(19) United States
(12) Patent Application Publication
(10) Pub. No.: US 2026/0142486 A1
(43) Pub. Date: May 21, 2026

(54) MULTIFUNCTIONAL PORTABLE POWER BANK AND SYSTEM

(71) Applicant: Shenzhen Quanyi Technology Co., Ltd., Shenzhen (CN)

(72) Inventor: Ninghua Chen, Shenzhen (CN)

(21) Appl. No.: 19/393,681

(22) Filed: Nov. 19, 2025

(30) Foreign Application Priority Data
Nov. 19, 2024 (CN) 202411649380.1

(51) Int. Cl. H02J 7/00

(52) U.S. Cl. CPC H02J 7/933; H02J 7/42; H02J 7/63; H02J 7/685; H02J 7/731; H02J 7/855

(57) ABSTRACT

The embodiments of the present disclosure provide a multifunctional portable power bank and system. The multifunctional portable power bank includes a controller and an interface assembly connected to the controller. When detecting the access of an electronic device, the interface assembly outputs a driving voltage to the electronic device to drive the electronic device to communicate with the controller. The controller identifies the device type and operating voltage of the electronic device according to the content of the communication, and controls the interface assembly to supply power to the electronic device according to the operating voltage. The above-mentioned multifunctional portable power bank and system can supply power to electronic devices without charging function, are applicable to different types of electronic devices, and save the cost of configuring rechargeable batteries in electronic devices and the purchase cost of users.

### CROSS-REFERENCE TO RELATED APPLICATIONS

The present application claims priority of Chinese Patent Application No. 202411649380.1, filed on November 19, 2024, the entire contents of which are hereby incorporated by reference.

### TECHNICAL FIELD

The present disclosure relates to the field of electronic technology, and in particular to a multifunctional portable power bank and system.

### BACKGROUND

With the development of society, portable electronic devices have become more and more popular, such as mobile phones, electric shavers, flashlights, windproof lighters, handheld fans, air pumps, etc. They all need to be powered by batteries to work, and also need charging management systems to be recharged and used repeatedly. However, these electronic devices are often used in certain scenarios and have a low frequency of use. For example, flashlights are mainly used when the power is cut off or in places with poor lighting at night; windproof lighters are used when ignition is needed such as lighting incense and candles; handheld fans are mainly used in scenarios such as traveling in summer or camping to make a fire; air pumps are mainly used for inflating balls or cars.

At present, portable electronic devices are generally equipped with lithium batteries, which can be recharged and used repeatedly. However, due to self-discharge of lithium batteries, the power will decrease or even the battery will be damaged if not used for a long time. In addition, equipping these low-frequency used electronic devices with rechargeable lithium batteries not only increases the purchase cost of users, but also causes serious waste due to the excessive use of lithium batteries during production.

### SUMMARY

The embodiments of the present disclosure provide a multifunctional portable power bank and system, which can supply power to various electronic devices of different types and models, improve the convenience of power supply when electronic devices are used, and also reduce production costs and purchase costs.

On one hand, the embodiments of the present disclosure provide a multifunctional portable power bank including a controller and an interface assembly. The interface assembly is connected to the controller and configured to output a driving voltage to an electronic device when detecting an access of the electronic device, so as to drive the electronic device to communicate with the controller. The controller is configured to identify a device type and an operating voltage of the electronic device according to contents of the communication, and supply power to the electronic device through the interface assembly according to the operating voltage.

On the other hand, the embodiments of the present disclosure provide a multifunctional portable power bank system including a multifunctional portable power bank and an electronic device. The multifunctional portable power bank includes a first controller and an interface assembly connected to the first controller. The interface assembly is configured to output a driving voltage to the electronic device when detecting an access of the electronic device, so as to drive the electronic device to communicate with the first controller. The first controller is configured to identify a device type and an operating voltage of the electronic device according to contents of the communication, and supply power to the electronic device through the interface assembly according to the operating voltage.

In each embodiment of the present disclosure, the multifunctional portable power bank includes a controller and an interface assembly connected to the controller. When detecting the access of an electronic device, the interface assembly outputs a driving voltage to the electronic device to drive the electronic device to communicate with the controller. The controller identifies the device type and operating voltage of the electronic device according to the content of the communication, and supplies power to the electronic device through the interface assembly according to the operating voltage. It is applicable to electronic devices of different types and different operating voltages, can supply power to electronic devices without charging function, and saves the cost of configuring rechargeable batteries in electronic devices and the purchase cost of users.

### BRIEF DESCRIPTION OF DRAWINGS

To more clearly illustrate the technical solutions in the embodiments of the present disclosure or the prior art, the following will briefly introduce the drawings needed in the description of the embodiments or the prior art. Obviously, the drawings in the following description are some embodiments of the present disclosure. For those skilled in the art, other drawings can be obtained according to these drawings without creative labor.

FIG. 1 is a schematic diagram of a multifunctional portable power bank provided by an embodiment of the present disclosure;

FIG. 2 is a schematic diagram of a multifunctional portable power bank provided by another embodiment of the present disclosure;

FIG. 3 is a schematic diagram of a multifunctional portable power bank provided by yet another embodiment of the present disclosure;

FIG. 4 is a schematic diagram of a multifunctional portable power bank system provided by an embodiment of the present disclosure;

FIG. 5 is a schematic diagram of a multifunctional portable power bank system provided by another embodiment of the present disclosure.

### DESCRIPTION OF EMBODIMENTS

In order to make the purposes, technical solutions and advantages of the embodiments of the present disclosure clearer, the technical solutions in the embodiments of the present disclosure will be clearly and completely described below with reference to the drawings in the embodiments of the present disclosure. Obviously, the described embodiments are part of the embodiments of the present disclosure, not all of them. Based on the embodiments in the present disclosure, all other embodiments obtained by those skilled in the art without creative labor belong to the protection scope of the present disclosure.

Hereinafter, the terms "comprise", "have" and their cognates that may be used in various embodiments of the present disclosure are only intended to indicate specific features, numbers, steps, operations, elements, components or combinations of the foregoing, and should not be understood as first excluding the existence of one or more other features, numbers, steps, operations, elements, components or combinations of the foregoing or adding the possibility of one or more other features, numbers, steps, operations, elements, components or combinations of the foregoing.

In addition, the terms "first", "second", "third", etc. are only used for distinguishing descriptions, and cannot be understood as indicating or implying relative importance.

Unless otherwise defined, all terms (including technical and scientific terms) used herein have the same meaning as commonly understood by those skilled in the art to which the various embodiments of the present disclosure belong. The terms (such as those defined in commonly used dictionaries) will be interpreted as having the same meaning as the contextual meaning in the relevant technical field, and will not be interpreted as having an idealized or overly formal meaning unless clearly defined in the various embodiments of the present disclosure.

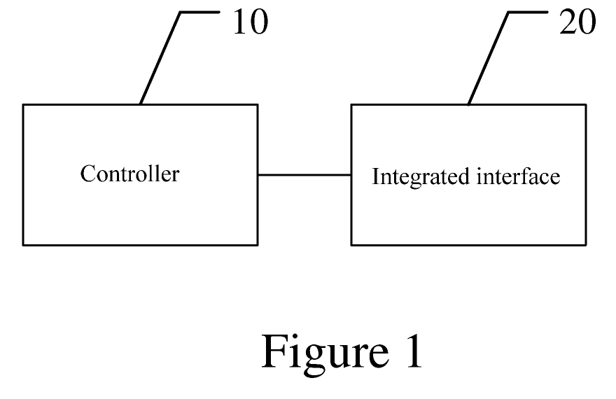

Please refer to FIG. 1, it shows a multifunctional portable power bank (hereinafter referred to as portable power bank), which can conveniently supply power to electronic devices without rechargeable batteries. The portable power bank includes a controller 10 and an interface assembly 20 connected to the controller 10.

The interface assembly 20 is configured to output a driving voltage to an electronic device when detecting an access of the electronic device, so as to drive the electronic device to communicate with the controller 10.

A content of the communication includes data such as a device type and an operating voltage sent by the electronic device, as well as data processed by the portable power bank.

The controller 10 is configured to identify the device type and operating voltage of the electronic device according to the content of the communication, and supply power to the electronic device through the interface assembly 20 according to the identified operating voltage of the electronic device, that is, output the operating voltage from the interface assembly 20 to the electronic device.

The driving voltage is the default output voltage of the portable power bank, such as 5V (volts), which is used to drive the electronic device to communicate with the portable power bank. The communication can be initiated by the portable power bank, and a communication request is sent to the electronic device through the controller 10, or the controller of the electronic device actively sends communication information, which includes the device type of the electronic device and the voltage required for work.

The controller 10 can specifically be a microcontroller unit (MCU) or a single-chip microcomputer and other chips with corresponding data processing capabilities.

In this embodiment, the multifunctional portable power bank includes a controller and an interface assembly connected to the controller. When detecting the access of an electronic device, the interface assembly outputs a driving voltage to the electronic device to drive the electronic device to communicate with the controller. The controller identifies the device type and operating voltage of the electronic device according to the content of the communication, and supplies power to the electronic device through the interface assembly according to the operating voltage. It is applicable to electronic devices of different types and different operating voltages, can supply power to electronic devices without charging function, and saves the cost of configuring rechargeable batteries in electronic devices and the purchase cost of users.

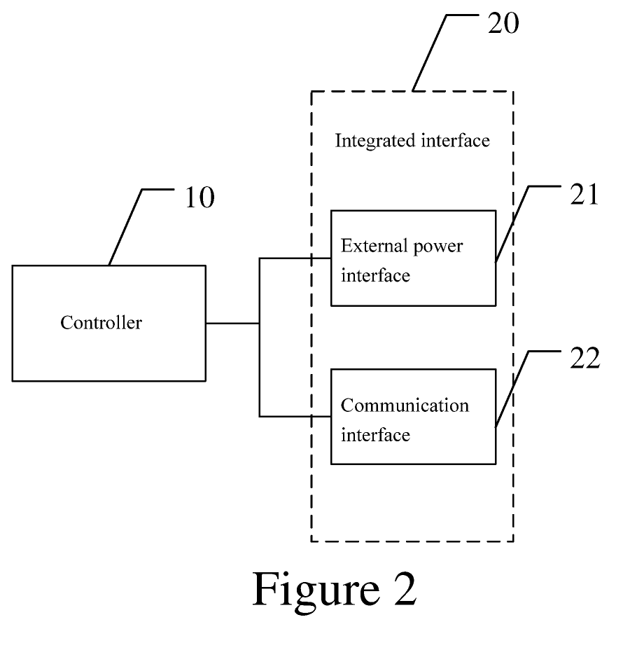

Referring to FIG. 2, the interface assembly 20 may include: a set of external power interfaces 21 and a set of communication interfaces 22.

The external power interface 21 is capable of outputting a voltage for supplying power to the electronic device.

The communication interface 22 has a communication function and is used for communication between the controller 10 and the electronic device.

The interface assembly 20 can specifically be a 4-Pin (4P) interface, where one set of 2P interfaces serves as a set of external power interfaces 21, and the other set of 2P interfaces serves as a set of communication interfaces 22.

The interface assembly 20 can also be a common-ground 3P interface, or a multi-Pin interface further including other interfaces for sharing current and voltage, which can realize a high-power interface. For example, 2P can realize 5A (ampere) current, and the other 2P can realize 8A or 9A current.

In another embodiment, the interface assembly 20 can also be a single interface, which has both power supply function and communication function, uses the power supply function to supply power to the electronic device, and uses the communication function to communicate with the electronic device.

The interface assembly 20 can specifically be a USB (Universal Serial Bus) interface.

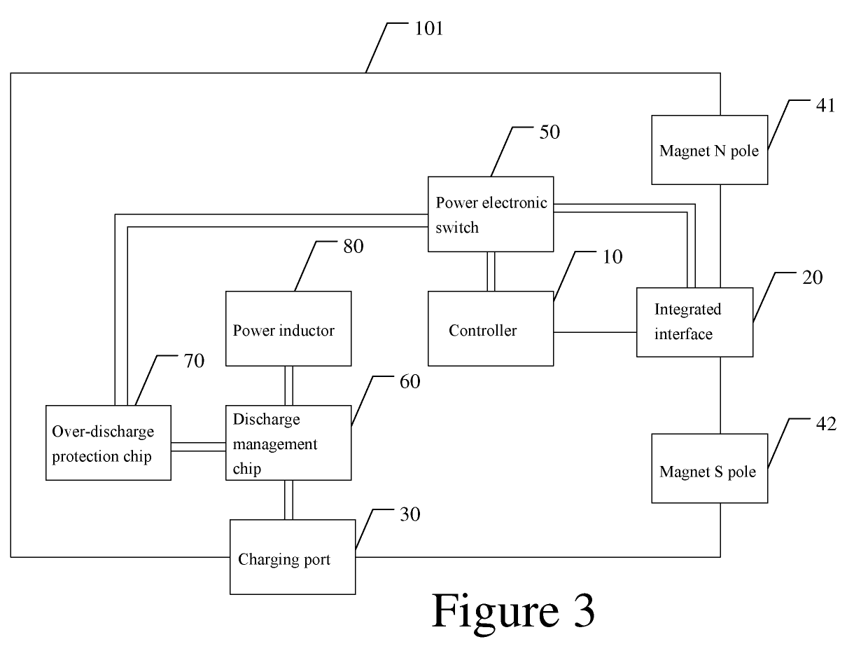

Referring to FIG. 3, the portable power bank further includes: a housing 101; a charging port 30 and a magnetic module arranged on the housing 101; a power electronic switch 50, a charge and discharge management chip 60, an over-discharge protection chip 70 and a power inductor 80 arranged in the housing 101.

The interface assembly 20 is arranged on the housing 101, and both the interface assembly 20 and the charging port 30 are exposed out of the housing 101 for electronic devices to access.

The magnetic module can be a magnet, which is used to adsorb the portable power bank to the electronic device through magnetic force, so as to prevent falling off during power supply and causing inconvenience in power supply.

Specifically, as shown in FIG. 3, the magnetic module includes a magnet N pole 41 and a magnet S pole 42, which are respectively arranged on both sides of the interface assembly 20. The housing of the electronic device is also provided with a magnetic module, which also includes a magnet N pole and a magnet S pole. By utilizing the principle of same-pole repulsion, it is used to cooperate with the polarities of the two magnets with opposite polarities on the electronic device through the polarities of the two magnets, so as to magnetically attract the electronic device to the mobile power supply, and the polarity of the interface assembly matches the polarity of the power supply interface of the electronic device. That is, when the magnet S pole of the electronic device corresponds to the magnet N pole of the portable power bank, and the magnet S pole of the electronic device corresponds to the magnet N pole of the portable power bank, the possibility of reverse connection of the positive and negative poles between the electronic device and the portable power bank is prevented.

The charging port 30 can be one or more charging ports of different types, used for charging the accessed electronic device with a rechargeable battery. The charging port can be a USB-A, TYPE-C, Lighting and other types of charging ports.

The power electronic switch 50 is connected to the controller 10, and is configured to output different voltages under the control of the controller 10, so that the interface assembly 20 outputs an operating voltage to supply power to the electronic device.

The over-discharge protection chip 70 is connected to the power electronic switch 50 and the charge and the discharge management chip 60.

The charge and discharge management chip 60 is also connected to the power inductor 80 and the charging port 30.

The charge and discharge management chip 60 is configured to perform a charging function. The charge and discharge management chip 60 needs to step up or down the voltage according to different protocols. The power inductor 80 is used for rectification during the charging process.

The over-discharge protection chip 70 is configured to monitor the battery power and cut off the circuit when the battery power is too low, so as to prevent the battery from being damaged due to over-discharge.

When the electronic device is connected to the communication interface 22, during communication between the electronic device and the portable power bank, it sends its own device type, operating voltage and other information according to an agreed protocol. The controller 10 is configured to, when detecting the device type and operating voltage of the electronic device sent by the electronic device through the communication interface 22 according to the agreed protocol, supply power to the electronic device through the external power interface 21 according to the operating voltage sent by the electronic device.

In another embodiment, the electronic device has a demand for switching the operating voltage. The controller 10 is further configured to, when detecting a switching operating voltage signal sent by the electronic device through the communication interface 22, supply power to the electronic device through the external power interface 21 according to the operating voltage requested to be switched in the switching voltage signal. For example, when the user adjusts the blowing gear when using a handheld fan, the handheld fan sends a signal for switching the operating voltage to the portable power bank through the communication interface 22. After detecting the signal sent by the handheld fan, the controller 10 of the portable power bank outputs the operating voltage from the external power interface 21 according to the operating voltage requested by the signal to supply power to the handheld fan according to the switched gear.

In another embodiment, the portable power bank can provide an operating voltage for the electronic device according to the user's selection. The portable power bank further includes an output voltage selection button. The controller 10 is configured to, when detecting that the output voltage selection button is operated by the user, supply power to the electronic device through the external power interface 21 according to the voltage selected by the user's operation. It can increase the diversity of selecting operating voltages for electronic devices and improve the convenience of supplying power to electronic devices.

In another embodiment, the portable power bank may further include a memory, and historical charging information is stored in the memory. If the controller 10 detects that the output voltage selection button is operated, it requests the device type from the accessed electronic device through the communication interface 22, acquires the device type, searches for the operating voltage corresponding to the device type in the historical charging information, and compares whether the found operating voltage is the same as the voltage corresponding to the output voltage selection button. If they are the same, it supplies power to the electronic device through the external power interface 21 according to the voltage; if not, it does not supply power and sends a prompt message to prompt that the operation of the output voltage selection button is incorrect. The prompt message can be text information displayed on the screen of the portable power bank, voice information played through the voice module of the portable power bank, or a beep or light emitted through the alarm module of the portable power bank for prompting. In this way, damage caused by incorrect manual selection of output voltage can be avoided and the intelligence of power supply of the portable power bank is improved.

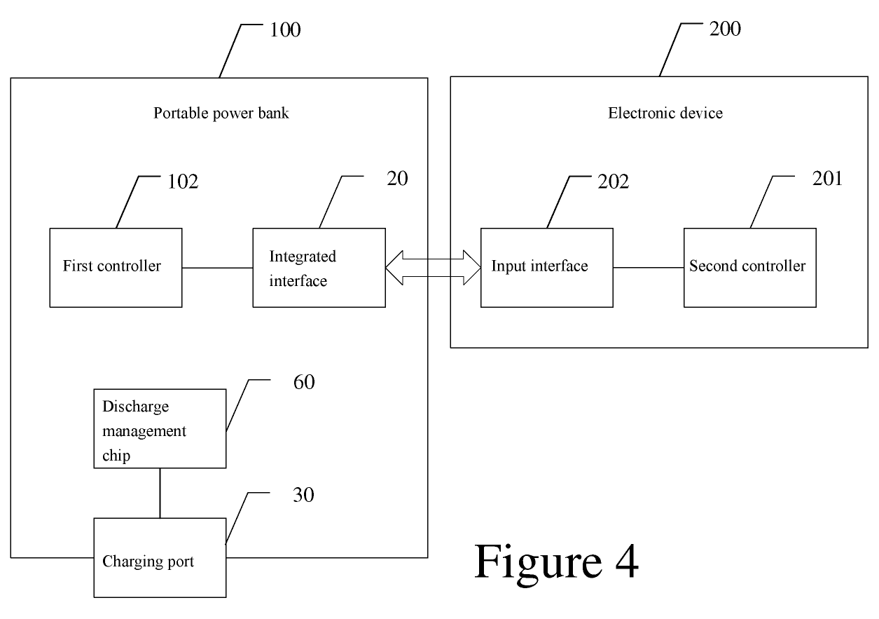

Referring to FIG. 4, an embodiment of the present disclosure further provides a multifunctional portable power bank system, including: a multifunctional portable power bank (hereinafter referred to as portable power bank) 100 and an electronic device 200.

The portable power bank 100 is the multifunctional portable power bank in the above embodiments.

The portable power bank 100 includes a first controller 102 and an interface assembly 20 connected to the first controller 102, and the first controller 102 can be the controller 10 in the above embodiments.

The electronic device includes a second controller 201; the electronic device 200 has an input interface 202 matching the interface assembly 20.

The interface assembly 20 is configured to output a driving voltage to the electronic device 200 when detecting the access of the electronic device 200, so as to drive the electronic device 100 to communicate with the first controller 102.

The first controller 102 is configured to identify the device type and operating voltage of the electronic device 200 according to the contents of the communication, and supply power to the electronic device 200 through the interface assembly 20 according to the operating voltage.

In this embodiment, the multifunctional portable power bank system includes a multifunctional portable power bank and an electronic device. The multifunctional portable power bank includes a first controller and an interface assembly connected to the first controller. When detecting the access of the electronic device, the interface assembly outputs a driving voltage to the electronic device to drive the electronic device to communicate with the first controller. The first controller identifies the device type and operating voltage of the electronic device according to the contents of the communication, and supplies power to the electronic device through the interface assembly according to the operating voltage. It is applicable to electronic devices of different types and different operating voltages, can supply power to electronic devices without charging function, and saves the cost of configuring rechargeable batteries in electronic devices and the purchase cost of users.

Further, the portable power bank 100 further includes a charge and discharge management chip 70 and a charging port 30 as described in the above embodiments.

The charging management chip 70 supports fast charging of different powers or voltages, and the supported voltages include, for example, 5V, 9V, 10V, 11V, 12V, 20V, etc. The external electronic device can be plugged into the charging port and make the charging management IC output the corresponding voltage by forging a protocol.

The electronic device 200 is connected to the charging port 30 of the portable power bank 100. The second controller 201 of the electronic device 200 is configured to send forged power supply information to the charging management chip 70, and the forged power supply information includes the simulated device type of the electronic device 200 and the required charging voltage.

The forged power supply information can be realized by forging a protocol. The second controller 201 is configured to send a forged protocol to the charging management chip 70, which includes the simulated device type of the electronic device 200 and the required charging voltage, so that the charging management chip 70 outputs the required charging voltage through the charging port 30 to charge the electronic device 200, instead of adapting the charging voltage corresponding to the device type according to the real device type of the electronic device 200.

The charging management chip 70 supplies power to the electronic device 200 through the charging port 30 according to the simulated required charging voltage.

The electronic device can request the charging management chip to output any supported charging voltage from the multifunctional portable power bank by forging a protocol, which can improve the flexibility and adaptability of charging.

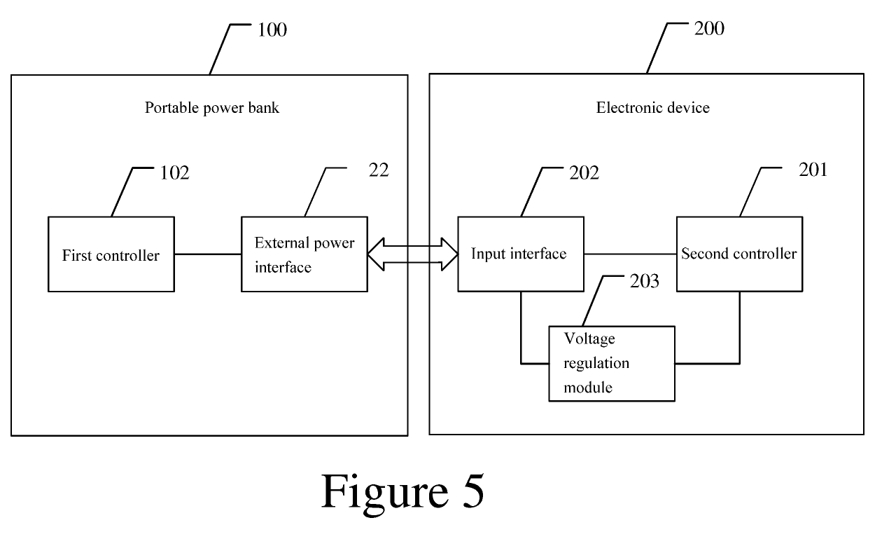

In another embodiment, referring to FIG. 5, the electronic device 200 further includes a voltage regulation module 203.

Compared with the above embodiments, the portable power bank 100 only provides a set of external power interfaces 22 for power output, or only uses the power supply function of the interface assembly 20 without communicating with the electronic device. If the controller 102 detects that the electronic device 200 is connected to the external power interface 22, it controls the portable power bank 100 to provide a unified driving voltage for the electronic device 200 through the external power interface 22 to drive the second controller 201 to work. The driving voltage can be the driving voltage in the foregoing embodiments, or a driving voltage of other values.

If the operating voltage of the electronic device 200 is inconsistent with the driving voltage, the slave controller 201 of the electronic device 200 controls the voltage regulation module 203 to step up or down the voltage according to the operating voltage requirement of the electronic device 200 based on the operating voltage, so that the driving voltage conforms to its own operating voltage and improves the adaptability to the portable power bank.

The voltage regulation module 203 can be a step-up/step-down circuit, which can realize step-up or step-down, and the specific circuit structure is not limited.

In the above embodiments, the description of each embodiment has its own emphasis. For the part not described in detail in a certain embodiment, reference can be made to the relevant descriptions of other embodiments.

The above is a description of the multifunctional portable power bank and system provided by the present disclosure. For those skilled in the art, according to the idea of the embodiments of the present disclosure, there will be changes in the specific implementation and application scope. In summary, the content of this specification should not be construed as a limitation to the present disclosure.

What is claimed is:

1. A multifunctional portable power bank, comprising:
a controller; and
an interface assembly connected to the controller and configured to output a driving voltage to an electronic device when detecting an access of the electronic device so as to drive the electronic device to communicate with the controller;
wherein the controller is configured to identify a device type and an operating voltage of the electronic device according to contents of the communication, and supply power to the electronic device through the interface assembly according to the operating voltage.

2. The portable power bank according to claim 1, wherein the interface assembly comprises a plurality of external power interfaces configured for supplying power to the electronic device and a plurality of communication interfaces configured for communication between the controller and the electronic device; or
the interface assembly is configured for supplying power to the electronic device and communicating with the electronic device.

3. The portable power bank according to claim 2, wherein the controller is further configured to, when detecting a switching operating voltage signal sent by the electronic device through the communication interface, supply power to the electronic device through the external power interface according to the operating voltage requested to be switched in the switching voltage signal.

4. The portable power bank according to claim 2, wherein the portable power bank further comprises an output voltage selection button; the controller is further configured to, when detecting that the output voltage selection button is operated, supply power to the electronic device through the external power interface according to the voltage selected by the operation.

5. The portable power bank according to claim 4, wherein the portable power bank further comprises a memory configured for storing historical charging information;
the controller is further configured to:
request the device type from the accessed electronic device through the communication interface, when detecting that the output voltage selection button is operated;
acquire the device type and search for the operating voltage corresponding to the device type in the historical charging information;
compare whether the found operating voltage is the same as the voltage corresponding to the output voltage selection button; supply power to the electronic device through the external power interface according to the voltage when they are the same, and do not supply power and send a prompt message to prompt that the operation of the output voltage selection button is incorrect when they are not the same.

6. The portable power bank according to claim 1, wherein the portable power bank further comprises two magnets with opposite polarities, the two magnets are respectively arranged on opposite sides of the interface assembly, and are configured to cooperate with the polarities of two magnets with opposite polarities on the electronic device to magnetically attract the electronic device to the portable power bank, and the polarity of the interface assembly matches the polarity of the power supply interface of the electronic device.

7. The portable power bank according to claim 1, wherein the portable power bank further comprises a plurality of charging ports of different types; the charging port is configured for charging the accessed electronic device with a rechargeable battery.

8. A multifunctional portable power bank system, comprising a multifunctional portable power bank and an electronic device;
the multifunctional portable power bank comprises:
a first controller; and
an interface assembly connected to the first controller and configured to output a driving voltage to the electronic device when detecting an access of the electronic device so as to drive the electronic device to communicate with the first controller; wherein the first controller is configured to identify a device type and an operating voltage of the electronic device according to contents of the communication, and supply power to the electronic device through the interface assembly according to the operating voltage.

9. The system according to claim 8, wherein the portable power bank further comprises: a charge and discharge management chip and a charging port; the electronic device comprises: a second controller; the second controller is configured to send forged power supply information to the charge and discharge management chip when detecting access to the charging port, and the forged power supply information includes the simulated device type of the electronic device and the required charging voltage; the charge and discharge management chip is configured to charge the electronic device through the charging port according to the required charging voltage.

10. The system according to claim 8, wherein the electronic device comprises a voltage regulation module; the first controller is configured to, when detecting that the external power interface is connected to the electronic device, output a driving voltage through the external power interface to drive the second controller to work; the second controller is configured to, when detecting that the value of the driving voltage does not conform to the operating voltage of the electronic device, control the voltage regulation module to adjust the driving voltage to the operating voltage required by the electronic device.
